(19) United States
(12) Patent Application Publication
(10) Pub. No.: US 2009/0150852 A1
(43) Pub. Date: Jun. 11, 2009

(54) METHOD OF ACTIVELY MANAGING SOFTWARE DESIGN DECISIONS

(75) Inventors: Jochen M. Kuester, Zurich (CH); Nelly A. Schuster, Kilchberg (CH); Michael S. Wahler, Zurich (CH); Olaf W. Zimmermann, Zurich (CH)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,841

(22) Filed: Dec. 5, 2007

(51) Int. Cl. G06F 9/44

(52) U.S. Cl. 717/101

(57) ABSTRACT

A method of actively managing software design decisions including identifying design model elements from a given requirements model, computing a design model element type for each of the design model elements, accessing reference architecture to locate one or more decision templates, confirming that a scope of the decision template is applicable to the design model element type, and if the scope of the decision template is applicable to the design model element type, generating decision instances based on the decision template to be applied to the design model element.

### BACKGROUND OF THE INVENTION

1. Field of the Invention

Aspects of the present invention are directed to a method for use in software design and, more particularly, to a method of actively managing software design decisions.

2. Description of the Background

Daring software construction processes, many design decisions have to be made and, as a result, several challenges exist. These challenges include how to identify the required decisions, including design alternatives, how to choose design alternatives that meet the functional and non-functional requirements in a given problem, project, and decision context, and which do not conflict with decisions already made and decisions to be made later, and how to enforce that made decisions lead to concrete actions and are implemented.

While tools for making software design decisions with ail three challenges in mind exist, these tools have major drawbacks in terms of decision identification, decision enforcement, and scalability. Conversely, operable process tools exist but may only describe steps or operations to be performed and/or what information should be captured without specifying implementations for doing so. Also, these tools may not be integral with analysis and design tools such that they cannot provide programming and/or communication interlaces that align design and decision modeling information.

### SUMMARY OF THE INVENTION

In accordance with an embodiment of the invention, a method of actively managing software design decisions is provided and comprises identifying design model elements from a given requirements model, computing a design model element type for each of the design model elements, accessing a reference architecture to locate one or more decision templates, confirming that these decision templates are applicable to the design model element type, and if the scope of the decision template is applicable to the design model element type, generating decision instances based on the decision template to be applied to the design model element.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a schematic diagram of an overview of decision space management organization according to an exemplary embodiment of the present invention; and

FIG. 2 is a schematic diagram of a smart importer according to an exemplary embodiment of the present invention.

### DETAILED DESCRIPTION OF THE INVENTION

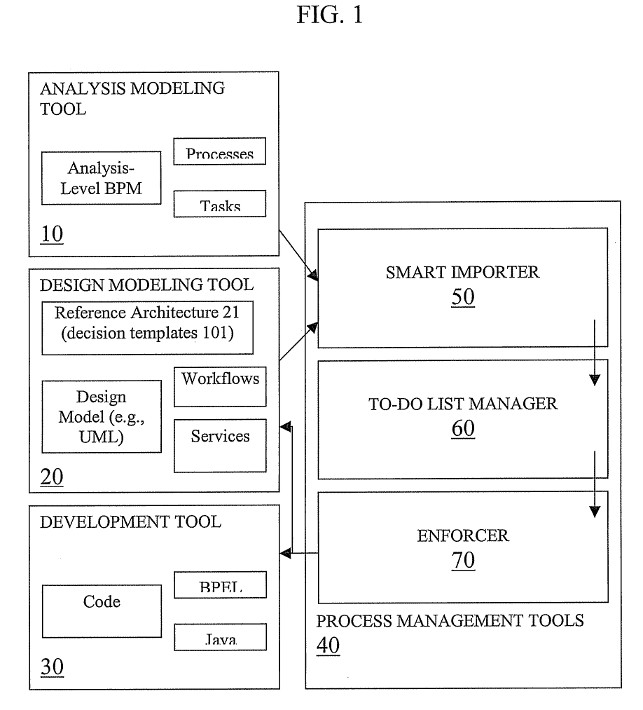

With reference to FIG. 1, decision space management organization includes an analysis modeling tool 10 in which, e.g., a business process may be expressed, a design modeling tool 20 in which, e.g., databases of known variables and constraints may be maintained, and a development tool 30 including coding instructions. The decision space management organization further includes process management tools 40, including a smart importer 50, which will be discussed in detail below, a to-do list manager 60 coupled to the smart importer 50, which manages to-do lists derived from the output of the smart importer, and an enforcer 70 coupled to the to-do list manager 60, which ensures that the items on the to-do lists are completed within given time constraints.

The analysis modeling tool 10 is employed in the development of, for example, analysis-level business process models (BPM). That is, when modeling a business process using the analysis modeling tool 10, one may discern and order a set of tasks that are components in the business process. This set of processes and tasks may be expressed in, e.g., a business process execution language (BPEL) and may be stored as BPEL in the development tool 30.

In an example, a business process in an analysis-level BPM may represent how a web browser allows human users to access and navigate a website. Among the tasks that would have to be accomplished for such a business process to be completed are to open a web browser window or tab (actor: user), to enter the URL of the website to be displayed (actor: user), to get the HTML content from the website (actor: web browser) and to render the content (actor; web browser).

Continuing the example, according to reference architecture (RA) for web browser designs, software components such as a web browser tab, a web browser window, and an HTTP client must be designed and implemented to address these requirements. In the design modeling tool 20, the web browser tab and the web browser window are represented as design model elements. Each of these design model elements is then understood as being a user interface element design model element type. When designing and implementing such software components, where to position the menu bar (i.e., menu positioning), how to color code the user interlace element and/or how to control accessibility to and from the user inter face element has to be decided.

The design modeling tool 20 maintains databases of known variables and constraints. That is, the design modeling tool includes the reference architecture (RA) 21, including decision templates 101 and design models comprising of representations of software components such as UML class diagrams representing the web browser tab, the web browser window, and the HTTP client. With respect to the decision instances 301, these are generated as analysis-level BPMs are completed and it becomes possible to analyze which decisions arise during the software construction process and which are necessary to implement the requirements stated in the analysis-level BPM. In the example, menu positioning, color coding, and accessibility control are design decisions required both for the web browser tab and the web browser window, but not for the HTTP client (the latter is not a user interface element).

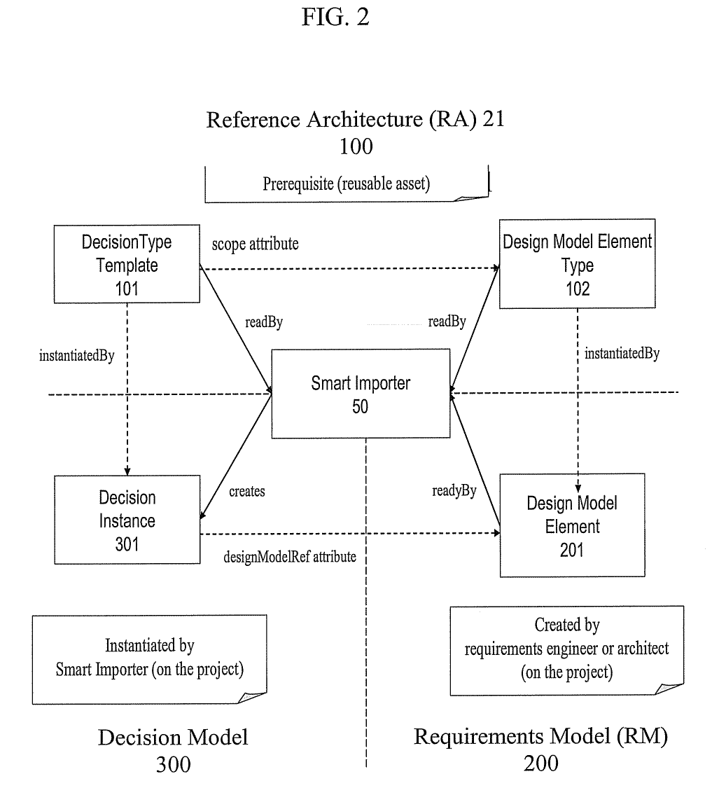

Still referring to FIG. 1, the smart importer 50 is coupled to the analysis modeling tool 10 and the design modeling tool 20 and generates decision instances 301 that populate the to-do lists managed by the to-do list manager 60 based on information received from the analysis modeling tool 10 and information, accessed in the design modeling tool 20. That is, the smart importer 50, which may comprise a set of computer readable executable instructions, operates according to an exemplary algorithm and thereby identities design model elements 201 of a requirements model (RM), as shown in FIG. 2, that are architecturally relevant, associates the design model elements 201 with concepts described in the reference architecture 21 and configures an initial decision space in accordance with information derived from the reference architecture 21 concepts.

In detail, with reference now to FIGS. 1 and 2, in an exemplary embodiment, a requirements engineer or a software architect may use the analysis modeling tool 10 to generate an analysis-level BPM that includes various processes and tasks that must be accomplished. The BPM is inputted into the smart importer 50 as the RM 200 and the smart importer 50 analyzes the RM so as to identity the architecturally relevant design model elements 201 therein.

In the example given above, it is noted that the identification of the architecturally relevant design model, elements 201, which are characterized by a high level of abstraction, would Identity the designing and the building of the web browser tab and web browser window functionality for a particular web browser that allows a user to access and navigate arbitrary websites as two exemplary design model elements 201 of the RM 200.

Once the design model elements 201 are identified, for each design model element 201, the smart importer 50 computes a design model element type 102. That is, the smart importer 50 determines a type of the design model element 201. The smart importer 50 accomplishes this by accessing the databases of the design modeling tool 20 in which a set of design model element types 102 are stored as prerequisites (or, reusable assets) 100 and by identifying a particular design model element type 102 for which the design model element 201 is an instance thereof.

Returning to the example, where the exemplary design model element 201 is the designing and the building of the web browser tab and the web browser window functionality for a particular web browser that allows a user to access and navigate arbitrary websites, the design, model element type 102, for which the design model element 201 is an instance, may be the user interface element. The RA for web browser design would characterize this software component type on a high, informal level of abstraction, stating that it is responsible for allowing a user to access and navigate a website.

Having computed the design model element type 102 for each design model element 201, the smart importer 50 again communicates with the design modeling tool 20 to access the databases relating to the reference architecture 21. The reference architecture 21 includes the set of decision templates 101 that have been developed previously from successfully completed software construction projects and, like the design, model element types 102, are stored as prerequisites (or, reusable assets) 100. Once the smart importer 50 locates a decision template 101 as a result of the accessing operation, the smart importer 50 confirms that a scope of the decision, template 101 is applicable to the design model element type.

Again returning to the example, a decision template 101 located during the accessing operation may refer to decisions relating to menu positioning, color coding, accessibility, etc. Such a decision template 101 may have been derived from an earlier successful web browser development project in which tabs and windows allowing for website access were designed for another web browser and where the decisions were found to be necessary operations toward completion of the previous RM. The decision template 101 will then be found applicable to the design model element type 102, discussed in the example (user interlace element), since decisions relating to menu positioning, color coding and accessibility are understood as being within the scope of the design model element type 102.

Once a decision template 101 having an appropriate scope is found, the smart importer 50 generates a decision model 300 including decision instances 301 based on the decision template 101. The decision instances 301 are to be applied to the design model element 201, such that, in accordance with the example, the smart importer 50 sends a message or otherwise notifies an appropriate entity, e.g., a software engineer, that decisions need to be made regarding menu positioning, color coding and accessibility for the two design model elements representing the tab and the window functionality.

In according with further embodiments of the invention, it is understood that the smart importer 50 may be embodied as a computer readable medium having executable instructions therein that execute the methods discussed above. Here, the requirements model, discussed above, is generated by an entity external to the smart importer 50 and that the design model element type 102 and the reference architecture 21 are reusable assets.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

We claim:

1. A method of actively managing software design decisions, comprising:
identifying design model elements from a given requirements model;
computing a design model element type for each of the design model elements;
accessing reference architecture to locate one or more decision templates;
confirming that a scope of the decision tent plate is applicable to the design model element type; and
if the scope of the decision template is applicable to the design model element type, generating decision instances based on the decision template to be applied to the design model element.

2. The method according to claim 1, further comprising repeating the accessing operation to locate a new decision template, if the scope of the decision template is not applicable to the design model element type.

3. A smart importer embodied as a computer readable medium having executable instructions therein to execute the method according to claim 1.

4. The smart importer according to claim 3, wherein the requirements model is generated by an entity external to the smart importer and wherein the model element type and the reference architecture are reusable assets.
